(19) United States
(12) Patent Application Publication
(10) Pub. No.: US 2009/0077634 A1
(43) Pub. Date: Mar. 19, 2009

(54) FIRMWARE UPDATE METHOD AND SYSTEM USING THE SAME

(75) Inventor: Shang-Ching Hung, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/857,516

(22) Filed: Sep. 19, 2007

(51) Int. Cl. G06F 9/44; H04L 9/32

(52) U.S. Cl. 726/4; 717/173

(57) ABSTRACT

A firmware update method and a system using the same are provided. The firmware update system comprises a device, a storage unit comprising a boot block code, and a network interface controller. When the system boots, the device executes the boot clock code, and determines whether an update alert exists. When the system boots, the network interface controller connects to a web server via Internet, downloads firmware from the web server, and generates the update alert after the firmware is downloaded. In response to the update alert, the device selects the firmware to be updated as an active code to the storage unit. The systems reboots after the firmware is updated to the device.

### BACKGROUND OF THE INVENTION

1. Field of the Invention

The disclosure relates generally to firmware update method and system using the same, and, more particularly to a firmware update method and a system using the same for automatically updating firmware via a network.

2. Description of the Related Art

Currently, many devices are special-purpose computers, executing specific firmware for functionality thereof. The firmware is a computer program or a binary image file embedded in a device, stored in a storage unit such as flash ROM of the device itself.

Firmware updates are required to fix bugs in the firmware, addressing functionality issues, and/or improving the performance and reliability of a device after the device is shipped. Conventionally, firmware updates must be manually performed using a software tool by users under an OS (Operating System) environment. In this method, users must understand software tools, and have related update technical knowledge. For general users, however, conventional firmware updates are complicated and inconvenient.

### BRIEF SUMMARY OF THE INVENTION

A firmware update method and a system using the same are provided.

In an embodiment of a firmware update method for use in a system comprising a network interface controller and a device, the network interface controller connects to a server via a network. At least one firmware is downloaded from the server. The firmware is updated to the device.

An embodiment of a firmware update system comprises a network interface controller and a device. The network interface controller connects to a server via a network, and then downloads at least one firmware from the server. The device receives the firmware, and updates accordingly.

Another embodiment of a firmware update system comprises a network interface controller and a device. The device comprises a storage unit comprising at least one boot block code. The device executes the boot clock code, and determines whether an update alert exists. The network interface controller connects to a server via a network, downloads at least one firmware from the server, and then generates the update alert after the firmware is downloaded. The device, in response to the update alert, selects the firmware to be updated as an active code to the storage unit. The system reboots after the firmware is updated to the device.

Firmware update methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of firmware update;

FIG. 2 is a schematic diagram illustrating an embodiment of a firmware update system;

FIG. 3 is a schematic diagram illustrating an embodiment of a storage unit;

FIG. 4 is a flowchart of an embodiment of a firmware update method for a network interface controller; and

FIG. 5 is a flowchart of an embodiment of a firmware update method for a device.

### DETAILED DESCRIPTION OF THE INVENTION

A firmware update method and a system using the same are provided.

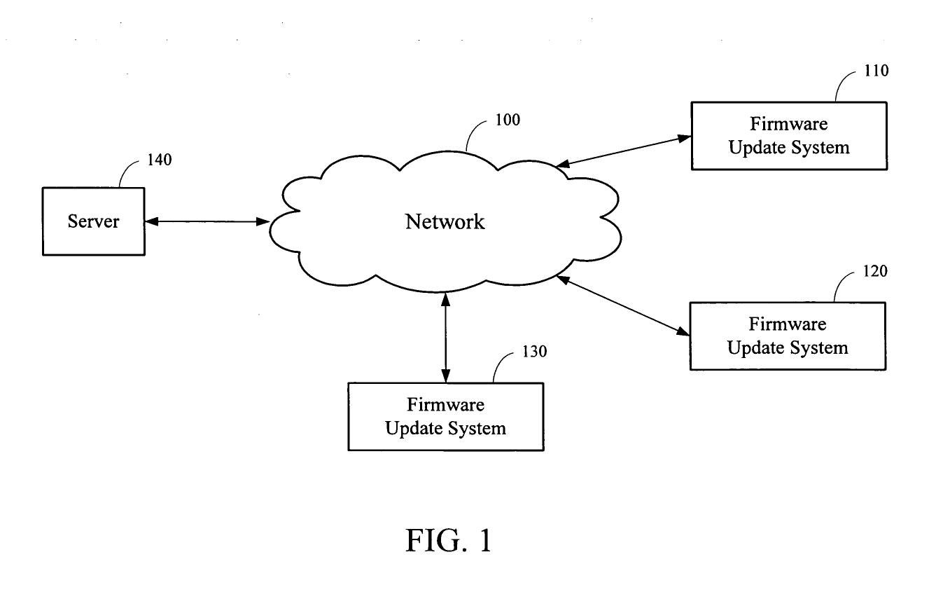

FIG. 1 is a schematic diagram illustrating an embodiment of firmware update.

As shown in FIG. 1, a plurality of firmware update systems 110, 120 and 130 can connect to a server 140 via a network 100 for firmware update. The firmware update systems may be any kind of processor-based electronic devices. The server 140 stores various versions of firmware for the firmware update systems. The network 100 may comprise Internet, Ethernet, Local area network (LAN), Wide area network (WAN), or wireless network. The server 140 may be a node device, a website or a database in the network 100. The firmware update systems are capable of connecting to the network 100 and downloading firmware from the server 140.

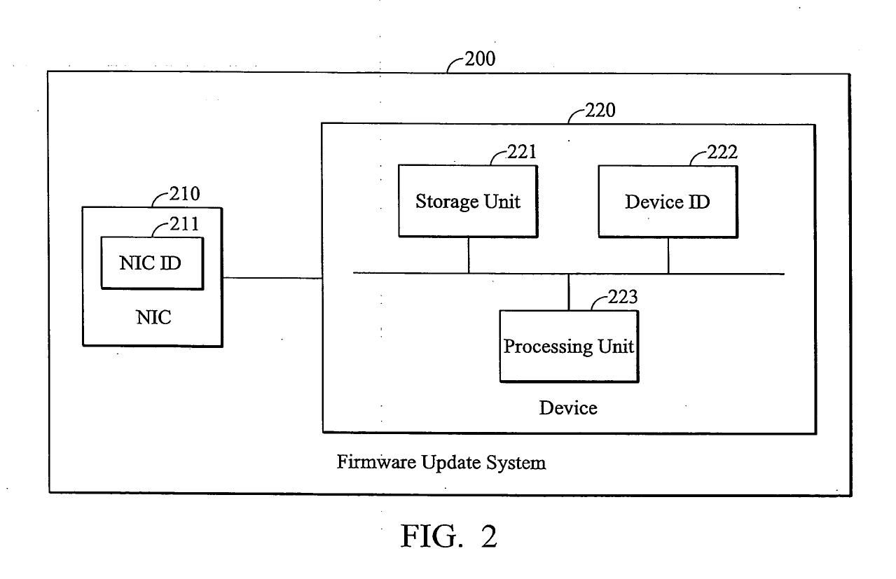

FIG. 2 is a schematic diagram illustrating an embodiment of a firmware update system.

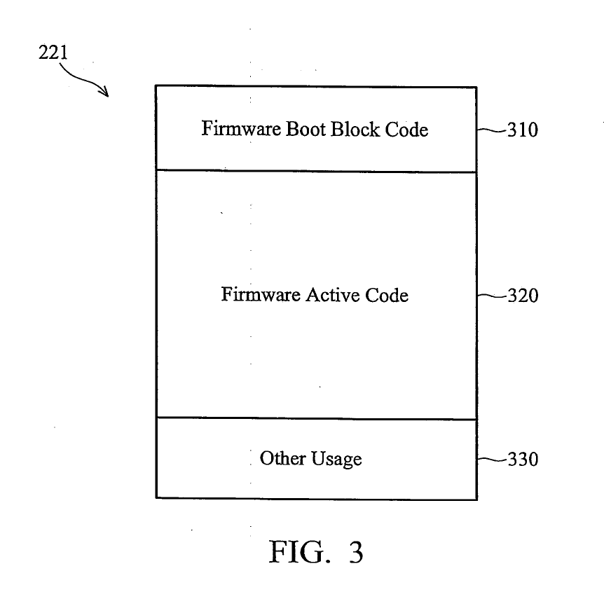

The firmware update system 200 comprises a network interface controller/chip/circuit (NIC) 210 and a device 220. The network interface controller 210 comprises an identification (NIC ID) 211. The NIC ID 211 may be a MAC address or an IP address of the network interface controller 210. The device 220 comprises a storage unit 221, a device identification 222, and a processing unit 223. FIG. 3 is a schematic diagram illustrating an embodiment of a storage unit. The storage unit 221 comprises at least three areas, respectively storing firmware boot block codes 310, firmware active codes 320, and data for other usage 330. The firmware boot block codes 310 are fixed and cannot be updated. The firmware boot block codes 310 may be instructions for checksum calculation, firmware update, and others. The firmware active codes 320 can be updated. When a firmware update is performed, downloaded firmware is used to update the firmware active codes 320. In some embodiments, the storage unit 221 may only have the firmware boot block codes 310 initially, following device shipment from a factory. The device identification 222 may be a slave address or specific name of the device. The processing unit 223 controls related components of the device, and performs the firmware update methods with the network interface controller 210. The storage unit 221 may be a memory. The processing unit 223 may be a micro controller or ASIC. The storage unit 221 and the device ID 222 may be formed in a unit. The storage unit 221 and the processing unit 223 may be formed in a unit.

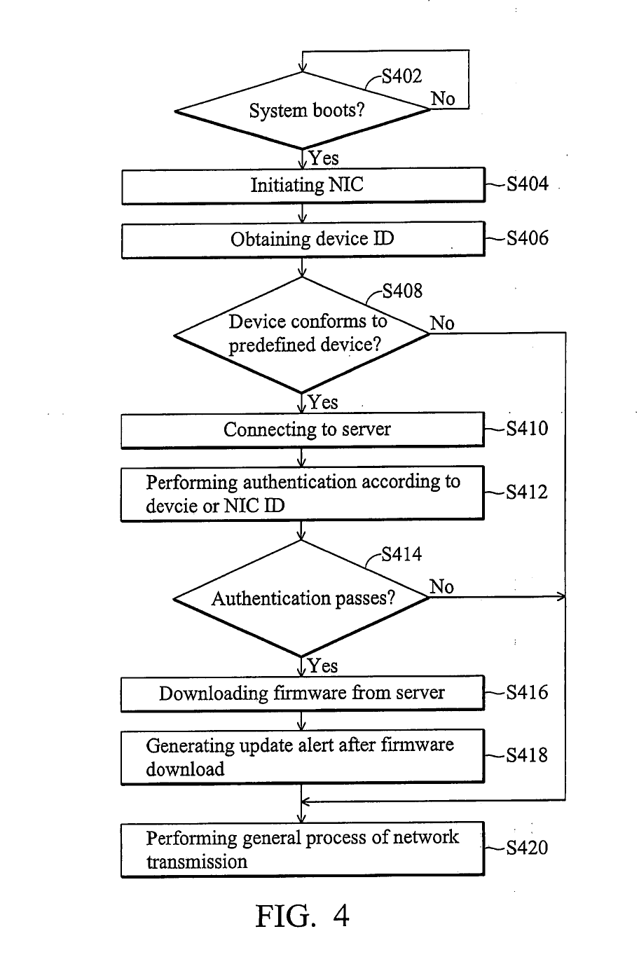

FIG. 4 is a flowchart of an embodiment of a firmware update method for a network interface controller.

In step S402, it is determined whether the firmware update system boots. If not (No in step S402), the procedure remains at step S402. If so (Yes in step S402), in step S404, a network interface controller initiates itself, and in step S406, obtains the device identification of a device. It is noted that the device identification may be a slave address or name of the device. In step S408, it is determined whether the device conforms to a predefined device according to the device identification. If not (No in step S408), in step S420, the network interface controller acts as a general network adapter, and performs general processes of network transmission. It is understood that if no device identification can be obtained, the procedure goes to step S420. If so (Yes in step S408), in step S410, the network interface controller, via a network, connects to a server according to a network address of the server. It is noted that the network address of the server can be recorded in the network interface controller in advance. Additionally, the device identification or the identification of the network interface controller (NIC ID) can be transmitted to the server during the connection. In step S412, the server performs an authentication according to the device identification or the identification of the network interface controller (NIC ID) to identify the firmware update system and determine whether the firmware update system has authentication to access the server. If the authentication fails (No in step S414), in step S420, the network interface controller acts as a general network adapter, and performs general processes of network transmission. If the authentication passes (Yes in step S414), in step S416, firmware is automatically selected according to the device identification or the identification of the network interface controller (NIC ID), and downloaded from the server to the firmware update system via the network. It is noted that the downloaded firmware can be stored in the storage unit or other memory in the device of the firmware update system, and not immediately updated to the device. After the firmware is downloaded, in step S418, an update alert is generated, and in step S420, the network interface controller performs general processes of network transmission. The usage of the update alert is discussed later.

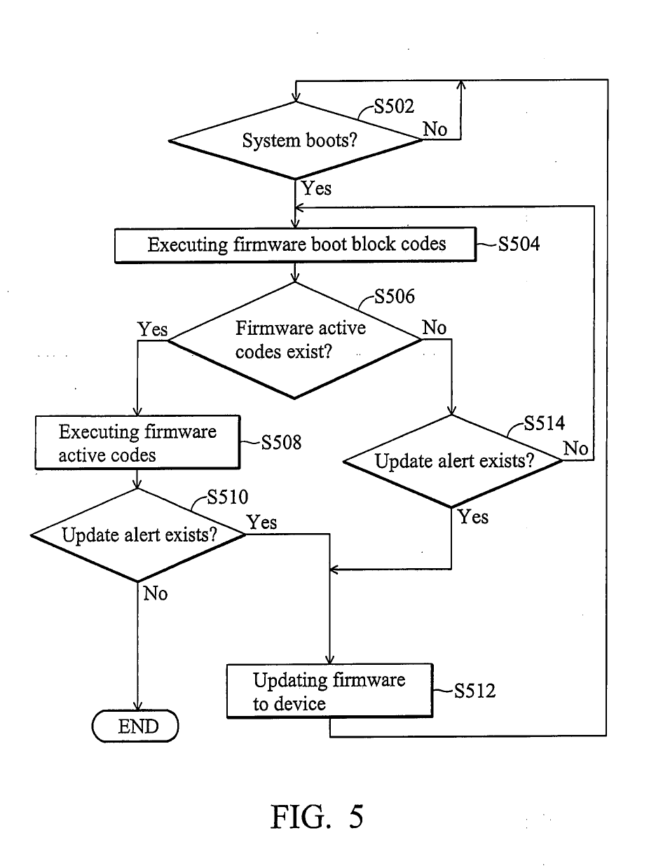

FIG. 5 is a flowchart of an embodiment of a firmware update method for a device.

In step S502, it is determined whether the firmware update system boots. If not (No in step S502), the procedure remains at step S502. If so (Yes in step S502), in step S504, a device executes firmware boot block codes in a storage unit. In step S506, it is determined whether any firmware active code exists in the storage unit. If so (Yes in step S506), in step S508, the firmware active code is executed. In step S510, it is determined whether any update alert exists. It is noted that the update alert may be generated by the network interface controller in FIG. 4. If not (No in step S510), the procedure is completed. If so (Yes in step S510), in step S512, the firmware is updated as the firmware active codes to the storage unit of the device. After the firmware is updated, the firmware update system reboots, and the procedure returns to step S502. If no firmware active code exists (No in step S506), in step S514, it is determined whether any update alert exists. If not (No in step S514), the procedure returns to step S504. If so (Yes in step S514), in step S512, the firmware is updated as the firmware active codes to the storage unit of the device. After the firmware is updated, the firmware update system reboots, and the procedure returns to step S502. It is noted that the steps of FIG. 5 may be proceeded after that of FIG. 4.

Firmware update methods and systems, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A firmware update method for use in a system comprising a network interface controller and a device, comprising:
connecting the network interface controller to a server via a network;
downloading at least one firmware from the server; and
updating the firmware to the device.

2. The method of claim 1, further comprising:
obtaining an identification of the device;
determining whether the device conforms to a predefined device according to the identification; and
if so, the network interface controller connecting to the server via the network.

3. The method of claim 1, further comprising:
obtaining an identification of the device or the network interface controller;
performing an authentication according to the identification; and
if the authentication passes, downloading the firmware from the server to the device.

4. The method of claim 3, further comprising:
automatically selecting the firmware according to the identification; and
downloading the selected firmware from the server to the device.

5. The method of claim 1, further comprising:
generating an update alert after the firmware is downloaded; and
selecting the firmware to be updated in response to the update alert.

6. The method of claim 1, further comprising:
the device executing at least one boot block code;
determining whether any active code exists in the device; and
if so, executing the active code.

7. The method of claim 6, wherein the firmware is used to replace the active code in the device.

8. The method of claim 1, further comprising:
rebooting the system after the firmware is updated to the device.

9. The method of claim 1, wherein the network interface controller comprises a network address of the server, and connects to the server accordingly.

10. A firmware update system, comprising:
a network interface controller, connecting to a server via a network, and then downloading at least one firmware from the server; and
a device receiving the firmware, and updating accordingly.

11. The system of claim 10, wherein the network interface controller further obtains an identification of the device, and determines whether the device conforms to a predefined device according to the identification, and if so, the network interface controller connects to the server via the network.

12. The system of claim 10, wherein the network interface controller further obtains an identification of the device or the network interface controller, and the server performs an authentication according to the identification, and if the authentication passes, the network interface controller downloads the firmware from the server to the device.

13. The system of claim 12, wherein the firmware is automatically selected according to the identification, and downloaded from the server to the device.

14. The system of claim 10, wherein the network interface controller further generates an update alert after the firmware is downloaded, and the device selects the firmware to be updated in response to the update alert.

15. The system of claim 10, wherein the device further executes at least one boot block code of the device, and determines whether any active code exists in the device, and if so, executes the active code.

16. The system of claim 15, wherein the firmware is used to replace the active code in the device.

17. The system of claim 10, rebooting after the firmware is updated to the device.

18. The system of claim 10, wherein the network interface controller comprises a network address of the server, and connects to the server accordingly.

19. The system of claim 10, wherein the network comprises Internet, Ethernet, Local area network (LAN), Wide area network (WAN), or wireless network.

20. A firmware update system, comprising:
a device comprising a storage unit comprising at least one boot block code, executing the boot clock code, and determining whether an update alert exists; and
a network interface controller, connecting to a server via a network, downloading at least one firmware from the server, and then generating the update alert after the firmware is downloaded,
wherein the device, in response to the update alert, selects the firmware to be updated as an active code to the storage unit, and the systems reboots after the firmware is updated to the device.

21. The system of claim 20, wherein the network interface controller further obtains an identification of the device, and determines whether the device conforms to a predefined device according to the identification, and if so, the network interface controller connects to the server via the network.

22. The system of claim 20, wherein the network comprises Internet, Ethernet, Local area network (LAN), Wide area network (WAN), or wireless network.
